(19) United States
(12) Patent Application Publication
(10) Pub. No.: US 2016/0190702 A1
(43) Pub. Date: Jun. 30, 2016

(54) SYSTEMS AND METHODS FOR PROVIDING A FREQUENCY SENSITIVE SURFACE ANTENNA

(71) Applicants: DON RUCKER, TEMECULA, CA (US); RON WESTBERG, TEMECULA, CA (US); PHIL NASH, TEMECULA, CA (US)

(72) Inventors: DON RUCKER, TEMECULA, CA (US); RON WESTBERG, TEMECULA, CA (US); PHIL NASH, TEMECULA, CA (US)

(21) Appl. No.: 14/799,470

(22) Filed: Jul. 14, 2015

Related U.S. Application Data
(60) Provisional application No. 62/024,895, filed on Jul. 15, 2014.

(51) Int. Cl. H01Q 13/08; H01Q 1/24; H01Q 1/48

(52) U.S. Cl. CPC H01Q 13/085; H01Q 1/48; H01Q 1/246

(57) ABSTRACT

Systems and methods for providing a multi-surface ground plane device for a wideband antenna which employs a frequency selective surface to optimize higher frequencies within the range of the wideband antenna and is especially well adapted for cellular communications for both data and voice but can be employed with any horn style wideband antenna.

### RELATED APPLICATIONS

This application claims priority to U.S. Provisional Patent Application Ser. No. 62/024,895 filed Jul. 15, 2014, entitled FREQUENCY SENSITIVE SURFACE ANTENNA, which is incorporated herein by reference.

### BACKGROUND OF THE INVENTION

1. Field of the Invention

The present invention relates generally to antennas employed in radio frequency (RF) transmission and communication. More particularly, the invention relates to a multi-surface ground plane device and method for a wideband antenna which employs a frequency selective surface to optimize higher frequencies within the range of the wideband antenna and is especially well adapted for cellular communications for both data and voice but can be employed with any horn style wideband antenna.

2. Background and Related Art

Electronic devices such as smart phones, cell phones, laptops, tablets, and the like conventionally communicate with cellular towers, computer networks, internet modems, Bluetooth, etc. via wireless radio frequency (RF) communication. This is accomplished through the employment of one or a plurality of antennas having radiator elements electronically integrated into the devices and configured to the task of transmitting and receiving at predetermined wavelengths for the desired purpose.

The frequency band of communication can vary widely depending on the type of wireless communications being implemented in a wireless grid, such as cellular or WiFi or digital communications for emergency services. The system requirements for gain, and individual employed frequencies can also vary depending on the FCC and client's needs. Also, a horizontal, vertical, or circular polarization scheme may be desired to either increase bandwidth or connections.

However, the type of wireless communication provided by a grid or other source is only useful when the receiving user device is able to receive transmissions, and the cell tower antenna can receive transmissions from the low-powered devices of remote users. Even with the advancements in the technology of smart phones and other devices, users often continue to experience poor cellular reception. This is contributed wholly, or in part, by the availability and quality of cellular grids in a certain area provided by cellular communication firms, as well as the quality of the antenna of the receiving device itself. Cellular providers are often limited to the quantity and location of which a cellular grid can be built. These grids are often considered eyesores in neighborhoods and public areas. Therefore, adding more or constructing larger grids to provide improved cellular reception to customers is often limited.

There has not been a highly signal sensitive and easily constructed for retrofit or for employment on wireless communications towers such as cellular antennas which is adapted to maximize reception from across a broadband of RF frequencies, which has excellent reception and throughput at both lower and higher frequencies. Most such antennas are either dipole antennas with limited wideband capability. Wideband horn style antennas have been proposed in prior art. However, many such wideband antennas which can suffer signal loss or poor performance at the lower or higher ends of the RF spectrum served, due to aspects of physical construction. Consequently, they may not provide optimum RF reception and transmission at all frequencies or bands for which the antenna is capable.

Thus, while techniques currently exist relating to wireless technologies, challenges still exist. Accordingly, it would be an improvement in the art to augment or even replace current techniques with other techniques.

### SUMMARY OF THE INVENTION

The present invention relates generally to antennas employed in radio frequency (RF) transmission and communication. More particularly, the invention relates to a multi-surface ground plane device and method for a wideband antenna which employs a frequency selective surface to optimize higher frequencies within the range of the wideband antenna and is especially well adapted for cellular communications for both data and voice but can be employed with any horn style wideband antenna.

At least some implementations relate to a broadband antenna device and method for improving RF reception and transmission for electronic devices employing RF communication means. Employed in combination with a wideband planar horn type antenna or radiator element, implementations of the present invention provide excellent throughput of RF signals along the entire spectrum served. Further, such an antenna and ground plane do not sacrifice the higher end frequencies of the RF range of the antenna at the expense of the lower end frequencies served by the wideband antenna and visa versa.

Implementations of the present invention herein disclosed and described provides a solution to the shortcomings in prior art in wideband antennas formed on planar substrate which employ a ground plane. The method and apparatus herein achieves the above noted goals through the provision of an antenna device which is uniquely configured with a ground plane configuration and construction which maximizes the radiated and received RF signals through the antenna element, across substantially the bandwidth served by the configuration of the wideband antenna.

In at least some implementations, the radiator element, or broadcast and receipt of the instant invention, employs a planar antenna element formed by printed-circuit technology although the novel ground plane configuration disclosed herein is applicable to other RF antennas served by such. The antenna element is of two-dimensional construction and is formed on a dielectric substrate of such materials as MYLAR, fiberglass, REXLITE, polystyrene, polyamide, TEFLON, fiberglass or any other such material suitable for the purpose intended.

One or a plurality of wideband antennas engaged in an array benefit with enhanced RF transmission and reception using the novel ground plane device and method which positions a unique two layer ground plane adjacent the radiator element of the antenna.

The antenna radiator element, capacitive patch or inductive strip, and feedline formed on the substrate, can be any suitable conductive material, as for example, aluminum, copper, silver, gold, platinum or any other electrical conductive material suitable for the purpose intended. The conductive material forming the element is adhered to the substrate by any known technology.

In a particularly preferred embodiment, the antenna radiator element is formed employing a Vivaldi style horn antenna which provides broadband RF reception across a wide range of frequencies. The lowest frequency is determined by the widest point between the horn edges, and the highest frequency is determined by the two most proximate edges which are positioned along opposing sides of a mouth area of the formed antenna.

Due to the ultra-wideband nature of the configuration of the antenna element herein, a ground plane height is particularly important to achieve optimized RF gain for specific frequencies. Because the planar horn antenna herein disclosed provides an ultra-wide band antenna, with a very wide bandwidth, it can be difficult to find the best Ground Height relative to the antenna element, to optimize both the low frequency range employed for instance by LTE/Cell communications, and the High frequency PCS bands, for optimized gain. Conventional planar ground plane devices positioned rearward and adjacent of the wideband antenna or array, do not always work well to maximize RF signal throughput across the entire range of RF frequencies in which the wideband element will operate.

In the device and method herein, which is particularly well suited for LTE, Cell, PCS bands and the Upper LTE/AWS Band, a unique two-level ground plane is provided having a first level to optimize the lower bands in the 700-990 MHz, with a larger ground plane which is about four inches below the slot forming the horn antenna.

However, the higher bands for PCS/AWS do not perform very well with ground plane positioned four inches below the slot distance for the frequencies of the disclosed antenna element, which works best for the lower band range. After numerous configurations with minimal results, the problem was solved using a unique Frequency Selective Surface (FSS) on a second ground plane level, which is placed above the lower ground plane at a distance of approximately 0.25″ below the slot of the horn antenna employed herein.

This unique double level ground plane configuration and method, optimizes the Upper PCS/AWS band, but concurrently it is invisible to and passes through, the Lower frequencies LTE/Cell. Conductive areas aligned with each other, and with the horn of the radiating element or antenna element, each of a length adapted to the frequencies desired, positioned on a dielectric material, on this second level ground plane, provide a device and method for maximized gain of the higher frequencies such as the PCS frequencies in the area of 1900 mhz served by the wideband antenna element.

The unique construction and dual level configuration of the ground plane for the radiating or antenna element thus provides two separate optimized RF reflective surfaces, both of which can be separately tuned and optimized for the RF bands serviced by the radiating element or antenna.

With respect to the above description, before explaining at least one preferred embodiment of the herein disclosed wideband antenna with layered ground plane invention in detail, it is to be understood that the invention is not limited in its application to the details of construction and to the arrangement of the components in the following description or illustrated in the drawings.

The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of the invention to provide a wideband transmit and reception antenna device which employs a dual layer ground plane configured to maximize broadcast and reception performance across the entire spectrum of the antenna.

It is another object of this invention to provide a method for configuring multiple layer ground plane surfaces which are tuned to the frequency ranges of an adjacent wideband antenna, to maximize gain across those frequencies.

These and other features and advantages of the present invention will be set forth or will become more fully apparent in the description that follows and in the appended claims.

The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 shows a perspective view of a particularly preferred mode of the device and method depicting the antenna or radiator element, formed on a non-conductive substrate, and an angled first ground plane layer backed by a metal ground plane;

FIG. 2 is a view of a first side of a preferred mode of the antenna element showing a mouth or uncovered area of dielectric material shaped much like a champagne glass;

FIG. 3 is again an overhead perspective view of the device of FIG. 1 showing the antenna of FIG. 2 surrounded on two sides by the first layer ground plane having a plurality of conductive surfaces forming lines thereon;

FIG. 4 shows a view of another preferred mode of the device having a alternatively configured array of radiator elements, and showing both the first surface ground plane and second surface ground plane;

FIG. 5 shows a view of the preferred antenna or radiator element with the feedline and pickup point overlain, and showing a typical first layer configuration where the formed lines are centered on the declining mouth area of the radiator element;

FIG. 6 shows an overhead perspective view of an array of antenna or radiator elements positioned in-between opposing rows of parallel lines of conductive material in first layer sections of the surrounding ground plane;

FIG. 7 shows a side perspective view of the device of FIG. 6 showing that the device and method for two layer ground plane works with any Vivaldi horn type radiator element which are shown in an array;

FIG. 8 shows another overhead perspective view of the device formed in an array of FIG. 7; and

FIG. 9 is an overhead view of an array of Vivaldi horn type radiator wideband elements interposed between surrounding first layer ground planes formed of conductive lines on a dielectric board of a length adapted to the desired frequency enhancement for the antenna or radiator element.

### DETAILED DESCRIPTION OF THE INVENTION

The present invention relates generally to antennas employed in radio frequency (RF) transmission and communication. More particularly, the invention relates to a multi-surface ground plane device and method for a wideband antenna which employs a frequency selective surface to optimize higher frequencies within the range of the wideband antenna and is especially well adapted for cellular communications for both data and voice but can be employed with any horn style wideband antenna.

In this description, the directional prepositions of up, upwardly, down, downwardly, front, back, top, upper, bottom, lower, left, right and other such terms refer to the device as it is oriented and appears in the drawings and are used for convenience only. The employment of such terms thus is not intended to be limiting or to imply that the device has to be used or positioned in any particular orientation.

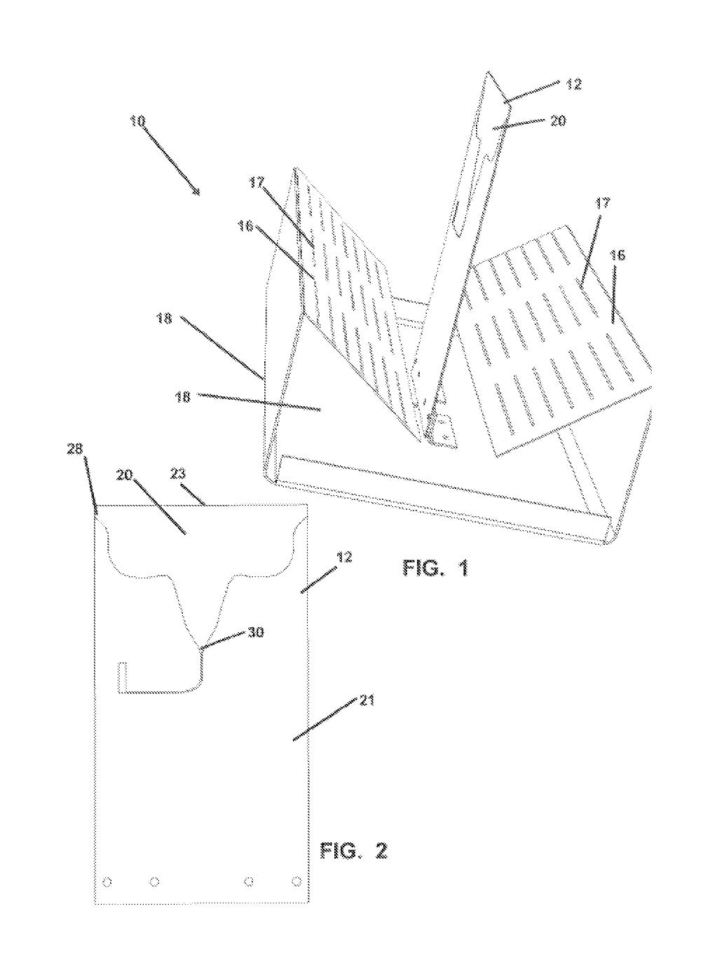

Now referring to drawings in FIGS. 1-9, wherein similar components are identified by like reference numerals, there is seen in FIG. 1, a perspective view of a particularly preferred mode of the device 10 and method depicting the antenna element 12 or radiator element, formed on a non-conductive dielectric substrate.

Also shown are the multiple layer ground plane configuration and method herein. A first ground plane 16 is positioned at an angle to the upright antenna element 12 is formed of dielectric material having conductive material thereon in the form of lines 17 in spaced parallel positions. A second ground plane 18 level or layer formed of a metal surface is positioned at the base of the antenna element 12 and in this case, about four inches from the level of the slot 20 of the planar Vivaldi type horn antenna element 12 providing the wideband RF reception and transmission capabilities being enhanced by the first ground plane 16 herein. Currently, a 100 degree bend around the antenna element 12 has shown to work well for the first ground plane 16.

FIG. 2 is a view of a first side of one preferred mode of the antenna element 12 formed of conductive material 21 on dielectric substrate. A mouth 23 or uncovered area of dielectric material shaped much like a champagne glass is depicted which has in testing excelled as a wideband radiator element or antenna element 12. The side edges of the mouth 23 move closer from a widest point 28 defining the lowest frequency of the antenna element 12 to a narrowest point of separation 20 defining the highest RF frequency of the antenna element 12. It is the reception and transmission at the higher end of frequencies which is enhanced significantly by the disclosed first ground plane 16 formed of dielectric material having conductive material forming lines 17.

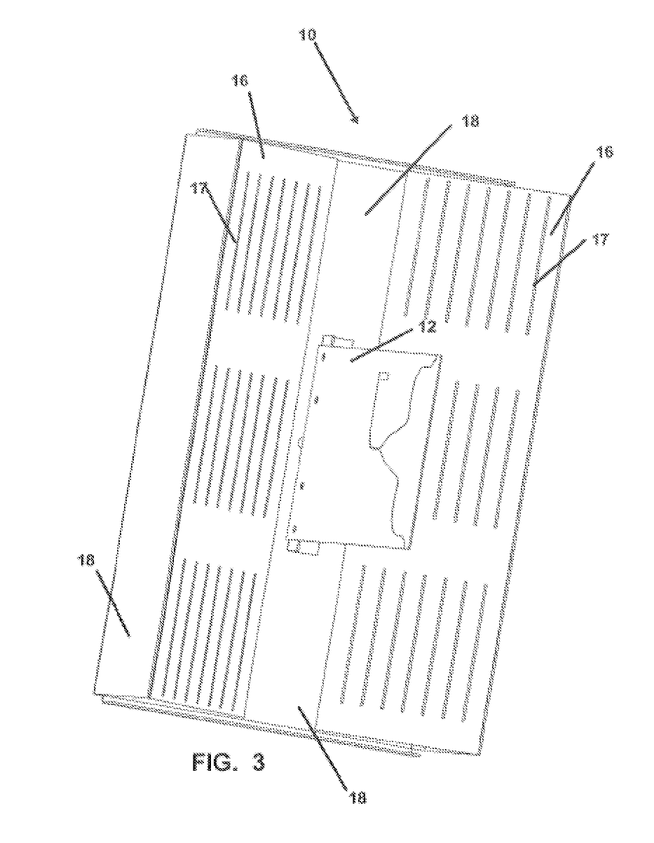

FIG. 3 is again an overhead perspective view of the device of FIG. 1 showing the antenna of FIG. 2 surrounded on two sides by the first layer ground plane having a plurality of conductive surfaces forming lines 17 thereon forming the reflective surface of the first ground plane. This surface is positioned currently substantially ¼ inch below the mouth 23. Both the length of the lines 17 which are currently about SO mils in width and currently about 3.19 inches long, and their spacing on the dialectic material forming the first layer of ground plane, can be adjusted to enhance different bands or frequency ranges.

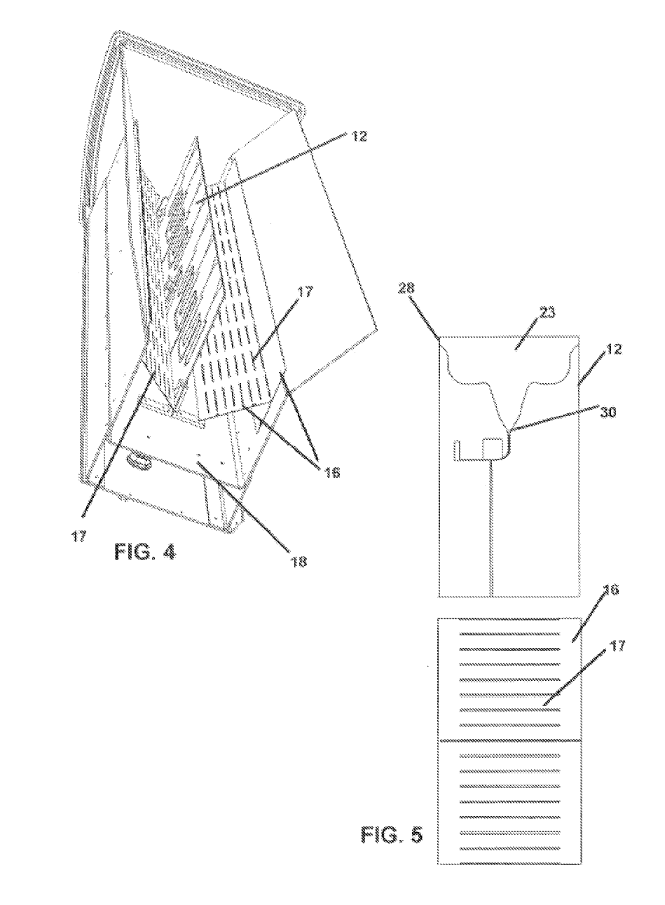

FIG. 4 shows a view of another preferred mode of the device 10 and method of employing layered or stacked ground planes where a first ground plane 16 formed of dielectric substrate having parallel lines 17 of conductive material is placed a distance from a second ground plane 18 formed of a metal or conductive surface. As depicted, the lines 17 currently work best to enhance the chosen frequencies when the lines are parallel and of substantially the same length, and where the center of the lines 17 align with the center of the narrowest point 30 of the formed mouth.

FIG. 5 depicts a view of the preferred antenna or radiator element 12 which has a mouth 23 defined by uncovered area of the dielectric substrate and the opposing side edges defining the mouth 23 from the widest to narrowest separation. This wideband element 12 has had excellent performance 450-1900 MHz and can be described as having a mouth 23 having an appearance of the top section of a champagne glass with the feedline and pickup point overlain, and showing a typical first layer configuration where the formed lines are centered on the declining mouth area of the radiator element 12. As noted the frequencies in the high end of the range are enhanced by the current device 10 and method of dual layered ground planes using aligned lines of a determined length formed of conductive material in the layer closest to the element 12. The center of the lines 17 currently is places to align with the center area of the mouth 23 about its narrowest point 30.

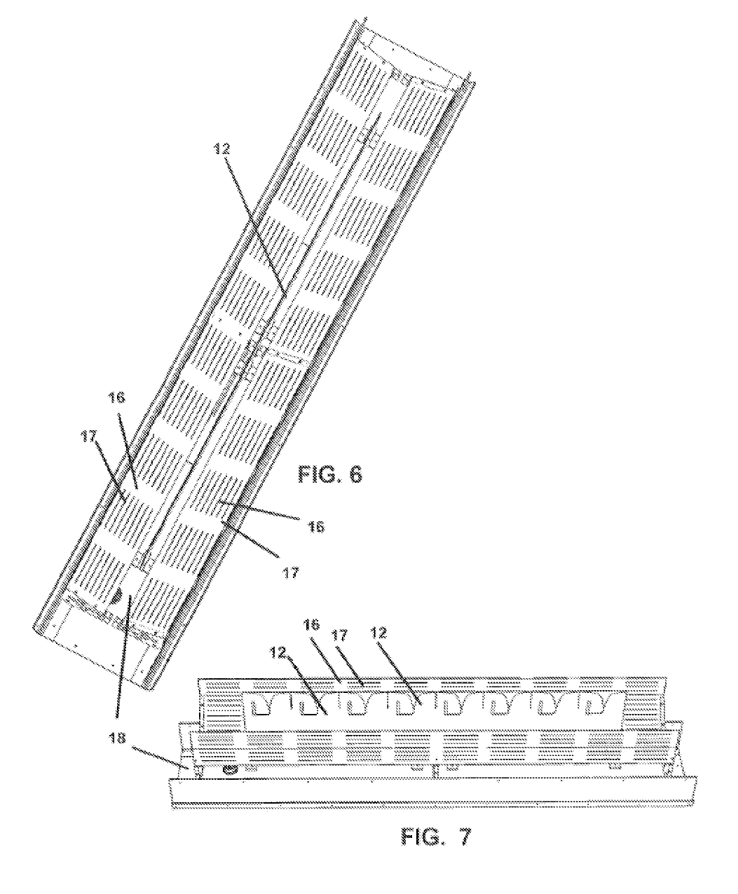

FIG. 6 shows an overhead perspective view of an array of antenna or radiator elements 12 centered in-between opposing rows first ground planes 16 of dielectric substrate with rows of conductive material forming parallel lines 17 on the first layer of surrounding ground plane. Also shown is the lower level second ground plane 18 which works in symbiotic relation with the elements 12 and first ground plane 16. A side view of this mode of the device can be seen in FIG. 7 and the alignment of the central portion of the parallel lines 17 with the center of the antenna or radiator elements 12.

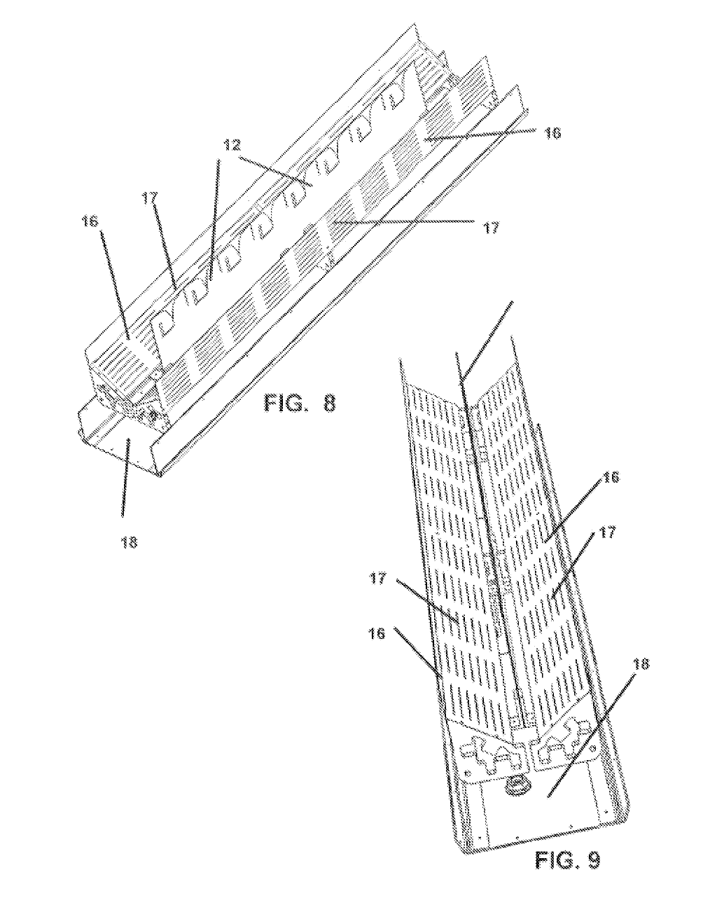

FIGS. 8 and 9 depict other views of arrays similar to that of FIGS. 6 and 7, showing that the two layer method and device for forming a ground plane for the centrally mounted antenna element 12 works with any Vivaldi horn type element and as noted works especially well with the element 12 shown in FIG. 2.

While all of the fundamental characteristics and features of the device and method have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

Thus, as discussed herein, embodiments of the present invention embrace antennas employed in radio frequency (RF) transmission and communication. More particularly, embodiments of the present invention relate to a multi-surface ground plane device and method for a wideband antenna which employs a frequency selective surface to optimize higher frequencies within the range of the wideband antenna and is especially well adapted for cellular communications for both data and voice but can be employed with any horn style wideband antenna.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An antenna device comprising a two layer ground plane in combination with a wideband antenna.
